(19) United States
(12) Patent Application Publication
(10) Pub. No.: US 2005/0224052 A1
(43) Pub. Date: Oct. 13, 2005

(54) High-pressure fluid injection circuit

(76) Inventor: Leonardo Caddedu, Crema (IT)

Correspondence Address: Leo H McCormick Jr, 2112 Mishawaka Avenue, PO Box 4721, South Bend, IN, 46634-4721, US

(21) Appl. No.: 10/516,226

(22) PCT Filed: May 26, 2003
(86) PCT No.: PCT/EP03/05482

§ 371 Date: Nov. 29, 2004

(30) Foreign Application Priority Data
May 29, 2002 (IT) 2002 A 000 453

(51) Int. Cl. F02M 1/00; F04B 11/00

(52) U.S. Cl. 123/467; 417/540

(57) ABSTRACT

A high pressure fluid injection circuit wherein a fluid which may generate pressure waves when flowing therein and generate pressure peaks which may damage the high pressure fluid circuit. To reduce both these pressure waves and the pressure peaks, a pressure wave absorber (14) including a cylinder, a rod (22) and a plurality of plates (23) is connected to the circuit. The plates (23) are positioned and made in such a way to provide a narrow passageway inside the cylinder that changes a regular movement of the fluid to an irregular movement such that the pressure peaks are reduced by 50% of their initial value.

### BACKGROUND OF THE INVENTION

The present invention relates to a high pressure fluid injection circuit. The object of the invention is to enhance the performance of the high pressure fluid injection circuit. The invention is more particularly designed for use in the automobile field but can also be applied in other fields. In the automobile field, this circuit can be used to inject a fluid at high pressure into at least one cylinder of an engine. In this case, the fluid is a fuel.

A fluid injection circuit comprises a fluid reservoir, a hydraulic pump for fluid injection at low pressure (approximately 10 bars, i.e. approximately 1,000,000 pascals) and at least one pump-injector. The reservoir, the injection pump and the pump-injector are linked by pipes enabling the fluid to flow from the reservoir via the injection pump to the pump-injector and then to continue flowing so that surplus fluid returns to the reservoir. The pump draws in a fluid obtained from the reservoir and increases the pressure of this fluid to a low pressure. In one example, this low pressure is at a pressure of 10 bars. This fluid under low pressure is then expelled from the injection pump through the pipes. A distributor distributes this fluid under low pressure among the different pump-injectors. Each pump-injector then increases the pressure to a maximum of 300 bars and injects it into its own cylinder at a maximum pressure of 2050 bars after a solenoid valve has opened.

An injection circuit comprising these pump-injectors capable of delivering a fluid at high pressure has the advantage of improved performance by comparison with a circuit comprising an injection pump delivering a lower injection pressure. In one example, a high injection pressure may be approximately 2000 bars. However, at high pressure the pump or pipes of the circuit may be damaged, and the performance of this kind of circuit decreases significantly.

In the invention, the cause of this deterioration was investigated, and, in particular, an attempt was made to strengthen the various elements of the circuit. This was unsuccessful or, to express it another way, costly. The idea then arose of detecting the transitory temporal variation of the pressure in the circuit during its operation.

It was then found that the delivery of a fluid at high pressure could cause the formation of a pressure wave. This pressure wave is due to a rapid opening and closing of the solenoid valve of the pump-injector. After the rapid closing of the solenoid valve, a pressure wave may be generated and may be propagated through the fluid, in the opposite direction to the flow of the fluid.

This pressure wave may also cause the formation of pressure peaks. If these pressure peaks are too high, they may damage elements of the injection circuit, thus decreasing the performance of the injection circuit at high pressure. For example, pressure peaks of 60 bars may be produced when pressure is delivered at 2,000 bars, and may damage the elements of the injection circuit.

In the prior art, fluid injection circuits were not affected by this pressure wave, since the fluid was pressurized at low pressure and since the elements of the circuits were strong enough not to be damaged by these pressure waves.

To limit the damage to elements of an injection circuit for pressurized fluid, particularly one for fluid at high pressure, the pipes could have been made wider and thicker. However, this solution would have made such a fluid injection circuit too bulky for use in a vehicle. In any case, it would not have resolved the problem of the pump.

### SUMMARY OF THE INVENTION

To attenuate these pressure waves which may potentially generate pressure peaks, the invention proposes a pressure wave absorber interposed in the pipes of the high pressure fluid injection circuit. In one example, this absorber is made in such a way that it forces the fluid to follow several different paths of different lengths. The direction of the fluid is such that the fluid must pass through these narrow passage sections, so that the movement of the fluid is accelerated. The acceleration of this fluid movement creates turbulence. This turbulence disrupts the regular movement of the fluid, thus attenuating the pressure wave and the consequent pressure peaks.

In this example, the absorber comprises a cylinder within which a rod is positioned. This rod is provided with plates which delimit open compartments. The fluid flows through these compartments via narrow passage sections.

The object of the invention is therefore a high pressure fluid injection circuit comprising a low pressure fluid injection pump linked by pipes to a reservoir on the one hand, and to at least one pump-injector, designed to deliver the fluid at high pressure, on the other hand, characterized in that it comprises a pressure wave absorber interposed between an output of the pump leading to the pump-injector and the pump-injector itself.

The invention will be more clearly understood from the following description and the accompanying figures. These figures are provided for guidance only and do not limit the invention in any way.

### BRIEF DESCRIPTION OF THE INVENTION

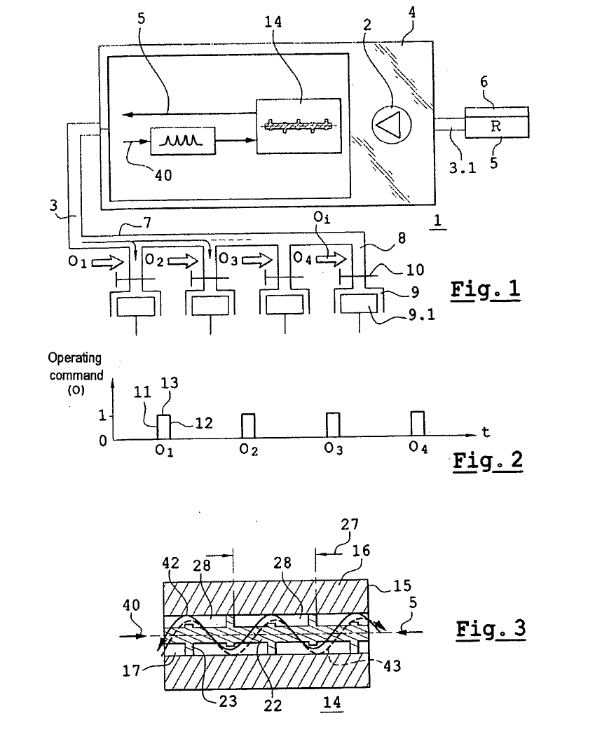

FIG. 1 is a schematic representation of a high pressure fluid injection circuit, according to the invention;

FIG. 2 is a graphic representation of at least one operating command of a solenoid valve as a function of time, according to the invention;

FIG. 3 is a longitudinal section through a pressure wave absorber according to the invention;

FIG. 4 is a transverse section through a pressure wave absorber according to the invention;

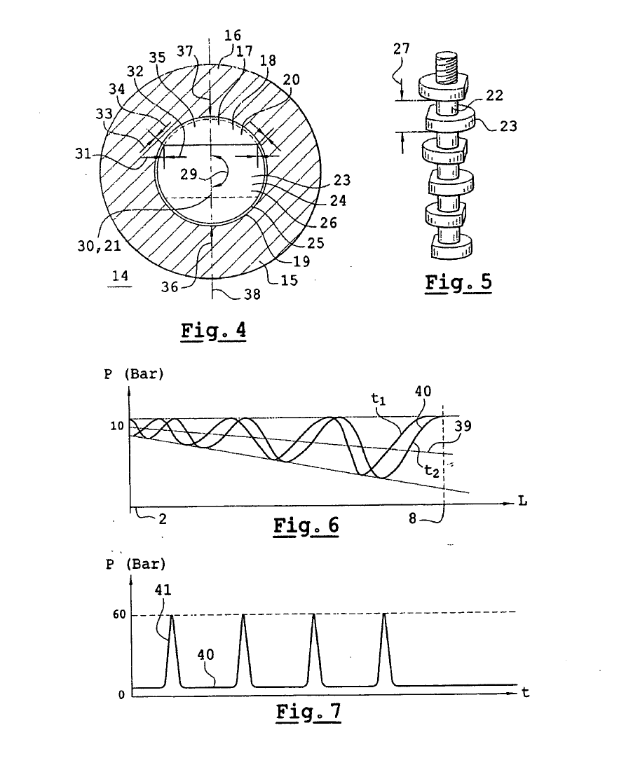

FIG. 5 is a three-dimensional representation of a wave absorber according to the invention;

FIG. 6 is a schematic representation of a pressure wave as a function of the distance traveled, according to the invention; and

FIG. 7 is a graphic representation of a pressure wave as a function of time.

### DETAILED DESCRIPTION OF THE INVENTION

FIG. 1 shows a high pressure fluid injection circuit 1 comprising a low pressure fluid injection pump 2 linked by pipes 3.1 and 3 to a reservoir 6 containing fluid 5 and to at least one pump-injector 8 respectively, according to the invention.

The pump 2 is incorporated in a housing 4. Fluid is supplied to this circuit in the following way. The pump 2 draws in the fluid 5 contained in the reservoir 6 through the pipe 3.1. In one example, the reservoir may contain fuel such as diesel oil. Having been pressurized in the pump 2, the fluid 5 is sent through pipes 3. In one example, the low pressure pump 2 increases the pressure of the fluid by approximately 10 bars. In this case, the pipes 3 comprise a distributor 7 linked to at least one pump-injector 8. In one example, the distributor 7 is linked to four pump-injectors 8. The pump-injector 8 is linked to a cylinder 9 of an engine (not shown) within which a piston 9.1 slides. The pump-injector is designed to expel a volume of fluid at high pressure through an aperture (not shown) which is blocked in the resting state by an injector needle (not shown). In one example, the pressure of the fluid at the moment of its expulsion from the pump-injector is 2050 bars. The pump-injector 8 is also provided with a solenoid valve 10, which is made to open 11 and close 12 by a command Oi (FIG. 2). For example, the solenoid valve 10 of each of the pump-injectors 8 is opened 11 and closed 12 by an operating command O1 to O4 (FIGS. 1 and 2). The solenoid valve thus enables each pump-injector to be supplied intermittently with fluid. In response to this command, the solenoid valve 10 can be in the opening state 11 or the closing state 12. The opening can be predetermined during a transitory period 13 to allow fluid to be pre-injected into the pump-injector. The fluid is then compressed inside the pump-injector to 300 bars. At 300 bars, the injector needle is displaced from the aperture of the pump-injector. The fluid is then expelled into the engine cylinder at a pressure of approximately 2050 bars, since the amount of fuel entering the pump-injector is greater than the quantity which can escape through the aperture of the pump-injector.

Fluid is returned toward the reservoir in the following way. The fluid flows in the opposite direction to that followed by the fluid for the supply of the circuit when the solenoid valve reopens. The excess fluid required for an effective pressure rise inside the pump-injector then returns to the reservoir through pipes (not shown) which are different from the pipes 3.

According to the invention, the high pressure fluid injection circuit 1 comprises a pressure wave absorber 14. The absorber 14 is interposed between an output of the pump 2 leading to the pump-injector 8 and the pump-injector 8 (FIG. 1). More precisely, and preferably, the absorber 14 is positioned inside the housing 4 of the pump 2, at the location of the output of the pump leading to the pump-injector 8. However, it could be positioned at another location along the pipes 3, preferably upstream of the distributor 7. In one example, this absorber 14 comprises a cylinder 15 (FIG. 4) with a solid outer part 16 and a hollow central part 17. A transverse section through the absorber shows a cross section 18 of the central part 17 of the cylinder 15 (FIG. 4). A perimeter 19, a surface 20 and a centre 21 can be distinguished in this cross section 18. In a preferred example, the cylinder 15 is circular (FIG. 4), but this cylinder 15 can also be rectangular.

A rod 22 is inserted at the location of the center 21 of this central part 17 (FIGS. 3 and 5). This rod 22 has at least one plate 23. The transverse section through the absorber 14 also shows a cross section 24 of the plate 23 (FIG. 4). A perimeter 25 and a surface 26 can be identified in this cross section 24. The rod 22 has a plurality of plates 23 (FIGS. 3, 4 and 5). In FIG. 3 it is possible to visualize a plate 23 in broken lines located below the plate 23 present in the plane of the drawing. In the preferred example, the rod 22 has six plates 23 and is sixty millimeters long (FIGS. 3 and 5). The plates 23 are positioned on the rod 22 in succession and are spaced apart by the same distance 27. The plates 23 delimit compartments 28 inside the central part 17 of the cylinder 15. In the preferred example, the plates 23 are in the shape of a disk cut along a chord, and delimit five compartments 28 (FIGS. 3, 4 and 5).

The plates 23 are identical and the perpendiculars to their chords are oriented at an angle 29 differing from one plate to the next with respect to an axis 30 defined by the rod 22 and passing through the center 21. Preferably, the plates 23 are oriented alternately at an angle of 180° to each other with respect to the axis 30 of the rod 22 (FIGS. 4 and 5). The plates 23 are positioned perpendicularly to the axis 30 (FIG. 3). In another example, it would be possible to provide an orientation at an angle other than 180°, thus producing a helical progression of these orientations.

According to the invention, the surface 26 of the plate 23 is equal to at least half of the surface 20 of the section 18 of the central part 17 of the cylinder 15. Additionally, the perimeter 25 of the plate 23 partially follows the perimeter 19 of the central part 17 of the section 18 of the cylinder 15 (FIG. 4).

The perimeter 25 of the plate 23 has a portion 31 and a portion 32. The portion 31 follows the perimeter 19 of the cylinder 15, whereas the portion 32 does not follow it (FIG. 4).

The perimeter 19 of the cylinder 15 also has a portion 33 which follows the plate 23 and a portion 34 which does not follow it. Thus the portion 32 of the plate 23 and the portion 34 of the cylinder 15 delimit an opening 35 which is lateral with respect to the axis 30 formed by the rod 22 (FIG. 4). Because of the presence of this lateral opening 35 in each plate 23, the compartments 28 are open inside the cylinder 15 (FIG. 3).

The plate 23 is made in such a way that, along an axis 38 perpendicular to the axis 30 formed by the rod 22, a point on the portion 31 of the perimeter 25 of the plate 23 is separated from another point on the portion 32 of the perimeter 25 by a distance 36.

Additionally, a point on the portion 32 is separated from a point on the portion 34 along the axis 38 perpendicular to the axis 30 of the rod 22 by a distance 37. In the preferred example, the distance 36 is 4.5 millimeters and the distance 37 is 1.5 millimeters, giving a diameter of 6 millimeters plus or minus 20%. Thus a good compromise is achieved between size and robustness.

When the fluid 5 at low pressure is injected into the pipes 3, the fluid 5 undergoes a slight pressure drop during its flow (FIG. 6). This slight pressure drop, or loss of head, is represented by a linear curve 39 decreasing as a function of the distance covered within the pipes 3. The moving fluid 5 strikes the solenoid valve 10 at the moment when the valve is closing. The fluid 5 is injected into the cylinder 9 by the rapid-opening and closing of the solenoid valve 10. The rapid closing 12 of the solenoid valve 10 operated by the command O creates a pressure wave 40 (FIG. 6). This wave 40 moves in the opposite direction to the movement of the fluid 5 when the circuit is supplied with fluid. This movement in the opposite direction takes place from the pump-injector 8 to the location of the pump 2.

This pressure wave 40 moves in space and in time (FIGS. 6 and 7). This pressure wave 40 emits at least one pressure peak 41 following the closing of the solenoid valve 10 (FIG. 7). For example, FIG. 7 shows four pressure peaks 41 of a pressure wave 40 caused by the successive opening 11 and closing 12 of the solenoid valve 10 of each of the four fluid pump-injectors 8. These pressure peaks 41 can reach a pressure of 60 bars.

The lateral openings 35 and the arrangement of the plates 23 with one above the next create restrictions and enlargements of section inside the cylinder 15 of the absorber 14. These restrictions and enlargements of sections disrupt the rectilinear trajectory of the fluid. The reverse wave must pass through the same areas.

The fluid 5 leaving the pump 2 enters the inside of the absorber 14. The trajectory 42 of the fluid inside the cylinder 15 has a sinusoidal shape (FIG. 3). At the opposite end to that at which the fluid 5 enters, the pressure wave 40 penetrates into the cylinder 15 and describes an identical trajectory 43, shown in broken lines in FIG. 3. The pressurized fluid 5 creates turbulence inside the compartments 28 after its passage through the lateral openings 35, thus significantly attenuating the pressure peaks of the pressure wave to as little as 50% of their maximum value.

1. A high pressure fluid injection circuit (1) comprising a low pressure fluid injection pump (2) linked by pipes (3, 3.1) to a reservoir (6) on the one hand, and to at least one pump-injector (8) for delivering the fluid at high pressure on the other hand, characterized in that it comprises a pressure wave absorber (14) interposed between an output of the pump leading toward the pump-injector and the pump-injector.

2. The circuit (1) as claimed in claim 1, characterized in that the absorber is placed in a housing (4) of the pump (2).

3. The circuit (1) as claimed in claim 2, characterized in that the absorber (14) comprises a cylinder (15) in which is inserted a rod (22) carrying at least one plate (23).

4. The circuit (1) as claimed in claim 3, characterized in that a surface (26) of a section (24) of the plate (23) is equal to at least half of a surface (20) of a section (18) of a central part (17) of the cylinder (15), and in that a perimeter (25) of the plate (23) partially follows a perimeter (19) of the section (18) of the cylinder (15).

5. The circuit (1) as claimed in claim 4, characterized in that a distance (36) separating a first point on a portion (31) of the perimeter (25) of the plate (23) following the perimeter (19) of the cylinder (15), on the one hand, from a second point on the perimeter (25) of the plate (23) which does not follow the perimeter (19) of the cylinder (15), on the other hand, this distance being measured along an axis (38) perpendicular to the axis (30) of the rod (22), is equal to 4.5 millimeters.

6. The circuit (1) as claimed in claim 5, characterized in that a distance (37) separating a second point on a portion (32) of the perimeter (25) of the plate (23) which does not follow the perimeter (19) of the cylinder (15), on the one hand, from a third point on a portion (31) of the perimeter (19) of the cylinder (15) which does not follow the perimeter (25) of the plate (23), this distance being measured along an axis (38) perpendicular to the axis (30) of the rod (22), is equal to 1.5 millimeters.

7. The circuit (1) as claimed in claim 4, characterized in that the rod (22) has a plurality of plates (23) and in that these plates (23) are positioned on the rod (22) in succession and are spaced apart by the same distance (27) between them.

8. The circuit (1) as claimed in claim 7, characterized in that the plates (23) are identical and are oriented at an angle (29) differing from one plate (23) to the next with respect to an axis (30) defined by the rod (22).

9. The circuit (1) as claimed in claim 8, characterized in that the plates (23) are oriented with respect to each other at an angle of 180° with respect to the axis (30).

10. The circuit (1) as claimed in claim 9, characterized in that the plate (23) is positioned perpendicularly to the axis (30).

11. The circuit (1) as claimed in claim 10, characterized in that a portion (32) of the perimeter (25) of the plate (23) which does not follow the perimeter (19) of the cylinder (15), combined with a portion (34) of the perimeter (25) of the cylinder (15) which is not followed by the perimeter (25) of the plate (23), delimits an opening (35) which is lateral with respect to the axis (30).

12. The circuit (1) as claimed in claim 11, characterized in that the rod (22) has six plates (23) delimiting five compartments (28) opened inside the cylinder (15).
